(19) United States
(12) Patent Application Publication
(10) Pub. No.: US 2013/0065214 A1
(43) Pub. Date: Mar. 14, 2013

(54) Educational Assessment Support Systems And Methods Associated Methods

(71) Applicant: Aileen Murphy-Swift, Kansas City, MO (US)

(72) Inventor: Aileen Murphy-Swift, Kansas City, MO (US)

(73) Assignee: Operation Breakthrough, Inc.

(21) Appl. No.: 13/231,728

(22) Filed: Sep. 13, 2011

(51) Int. Cl. G09B 7/00; G09B 19/00

(52) U.S. Cl. 434/350; 434/236; 434/353; 434/362

(57) ABSTRACT

A system and method assess educational development of a child. Indication of accomplishment by the child of a plurality of tests is entered into the system. A report is generated to indicate educational areas of concern and strength for the child.

### BACKGROUND

Education of young children between the ages of 6 months to 6 years is critical for enabling the child to successfully learn in a conventional educational environment. A child that is not prepared for learning in school typically falls behind at an early stage and then drops out of education at an early stage. Identification of children at risk and providing the necessary help needed is difficult, typically relying upon human resources entirely. Children of families living in poverty are typically the most at risk, and identifying deficiencies in each child and their individual needs is difficult. Thus, many children arrive unprepared for schooling at kindergarten, and such unpreparedness typically holds the child back throughout the rest of the educational process.

### SUMMARY OF THE INVENTION

The Operation Breakthrough Collaborative is an innovative approach to ensure young children, particularly those living in poverty, are academically, physically and emotionally ready for kindergarten. Developed by Operation Breakthrough's Early Education staff in partnership with the Stanley H. Durwood Foundation, the program is based on a comprehensive assessment of children's developmental strengths and delays, followed by educational programming and strategic interventions that address each child's individual challenges.

In one embodiment, a computer-implemented method for educational assessment of a child is performed by analyzing assessment information relating to the child, including physical health and development, approaches to learning, creative arts, language development, literacy, mathematics, and science. The present system then uses the assessment information to generate an education assessment report, including (a) indications of the child's areas of strength, (b) indications of the child's areas of concern, and (c) intervention recommendations based upon the indications.

### BRIEF DESCRIPTION OF THE DRAWINGS

FIG. 1 shows one exemplary educational assessment support system, in an embodiment.

FIG. 2 shows exemplary structure of the assessment data of FIG. 1, including tasks/tests, indicators, elements, and domains, in an embodiment.

FIG. 3 is a flowchart illustrating one exemplary process for educational assessment support, in an embodiment.

FIG. 4 is a flowchart illustrating one exemplary sub-process of the process of FIG. 3 for calculating indicator results.

FIG. 5 is a flowchart illustrating one exemplary sub-process of the process of FIG. 3 for calculating element results.

FIG. 6 is a flowchart illustrating one exemplary sub-process of the process of FIG. 3 for calculating domain results.

FIG. 7 shows seven exemplary domains of the assessment data of FIG. 1, in an embodiment.

FIG. 8 shows twenty-eight exemplary elements grouped by the domains of FIG. 7, in an embodiment.

FIGS. 9A-9D show exemplary indicators grouped by the elements of FIG. 8, in an embodiment.

FIG. 10 is a flowchart illustrating exemplary support of a child using the system of FIG. 1, in an embodiment.

FIG. 11 is a flowchart illustrating exemplary training and assessment of teachers using the system of FIG. 1, in an embodiment.

### DETAILED DESCRIPTION

A collaborative program is created to assess and intervene when necessary in the development of young children. The collaborative program is staffed by part-time long term staff and full-time staff that provide technical assistance on a regular basis to partner agencies. All staff work with directors, coordinators and teachers to complete assessments, professional development and ensure program fidelity through the duration of the program.

Essential components of the collaborative program are outlined in brief below and follow the implementation sequence. These components will be customized to meet the needs and resources of each program partner. The environment, structures, services, systems, and classroom operation of any partnering agency is assessed. Children are assessed to identify each child's strengths/deficiencies in seven domains of development and to establish a baseline for each child. The collaborative program includes on on-going assessment, record-keeping, and instructional planning procedures designed to monitor skill development of each child from and age of 6 weeks to 6 years. The collaborative program restructures and develops to define and establish interdisciplinary planning processes, staff leadership committees, staff meeting structures, and sound evaluation processes.

Implementation of the collaborative program includes consistent, on-going data collection for child, classroom and center-wide reporting. Curriculum follows a universal guidance plan with a plurality of automatically selected (e.g., by system 100) interventions to address individual challenges of each child. Clinics/workshops provide professional development to facilitate transfer of knowledge in child development, individualized interventions, and so on. For example, training may include implementation of Theraplay® in the classroom setting. Team collaboration and guided teacher planning time is coordinated within the collaborative program.

A critical component for a child's academic success is the formation of family partnerships to actively engage families in their children's learning. Activities for families are diversified in delivery and tied to program goals. To address family needs and to build strong family support networks, connections are formed between the families and community resources. The collaborative program includes continual refinement and development to address emerging challenges of each child.

In the following description, an assessor utilizes a system and methods for assessing a child. Although the description describes the assessment of one child, the systems and methods herein may be used to assess educational development of children between birth and the age of six years or until regular schooling is started by the children. The system and methods may allow analysis between different physical areas, different educators and interventionists, and also allow evaluation of the interventions themselves. The system and methods provide analysis of the children and may suggest appropriate intervention for the child to improve the education and/or care of the child in educational areas of concern.

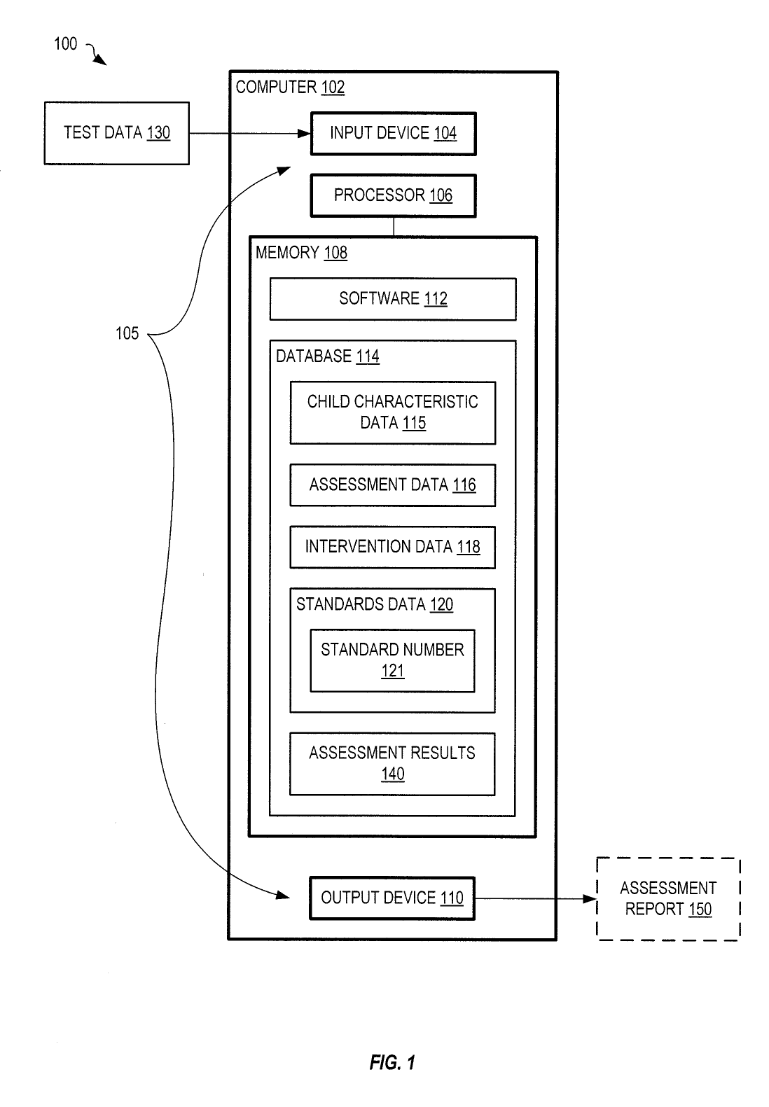

FIG. 1 shows one exemplary educational assessment support system 100 for receiving, analyzing and advising on a child's education and needs. System 100 includes a computer 102 with an input device 104, a processor 106, a memory 108, and an output device 110. Memory 108 is shown storing software 112 and a database 114.

Computer 102 may represents one or more of a personal computer, a server, a laptop computer, a notebook computer, and a tablet computer. Although only one processor 106 is shown, computer 102 may include multiple processors without departing from the scope hereof. Memory 108 may represent one or both of volatile memory (e.g., RAM, DRAM) and non-volatile memory (e.g., FLASH, Magnetic Media, Hard Drive, etc.), and is in communication with processor 106. Input device 104 may represent one or more of a keyboard, a mouse, a touch screen interface, a magnetic reader, an optical reader, and so on. Output device 110 may represent one or more of a display screen, a printer, a magnetic writer, an optical writer, and so on. Input device 104 and output device 110 cooperate to form a user interface 105. Software 112 represents one or more algorithms that when executed by processor 106 control computer 102 to receive, analyze, and advise on a child's education and needs. Database 114 is shown storing child characteristics 115, assessment data 116, intervention data 118, standards data 120, and assessment results 140.

Child characteristic data 115 includes one or more of: name, enrollment date, birth date, neighborhood, class, gender, race, high risk, parent graduated high school, three or more siblings, and chronic homelessness. Other classifying information may be included within child characteristics 115 without departing from the scope hereof. Assessment data 116 represents collected and derived information on the child. Intervention data 118 represents optional interventions that may be selected by system 100 to help the child, when necessary. Standards data 120 defines a number of accomplishments that the child is expected to have achieved based upon the age of the child. Assessment results 140 represents assessment information and intervention recommendations for the child based upon the assessment data 116, intervention data 118 and standards data 120. Assessment results 140 may be output from output device 110 as one or more reports 150 that may include one or more graphs, tables, and other visual data based upon assessment results 140.

Test data 130 represents information received using input device 104 for the child being assessed and is stored as assessment data 116 within database 114. Assessment data 116 may also include other information derived by software 112 from test data 130. One or more algorithms of software 112 are executed by processor 106 to generate assessment results 140, also stored within database 114, that may include analysis results based upon assessment data 116 and standards data 120, and intervention suggestions based upon assessment data 116, standards data 120, and intervention data 118. Assessment results 140 are output by output device 110, for example.

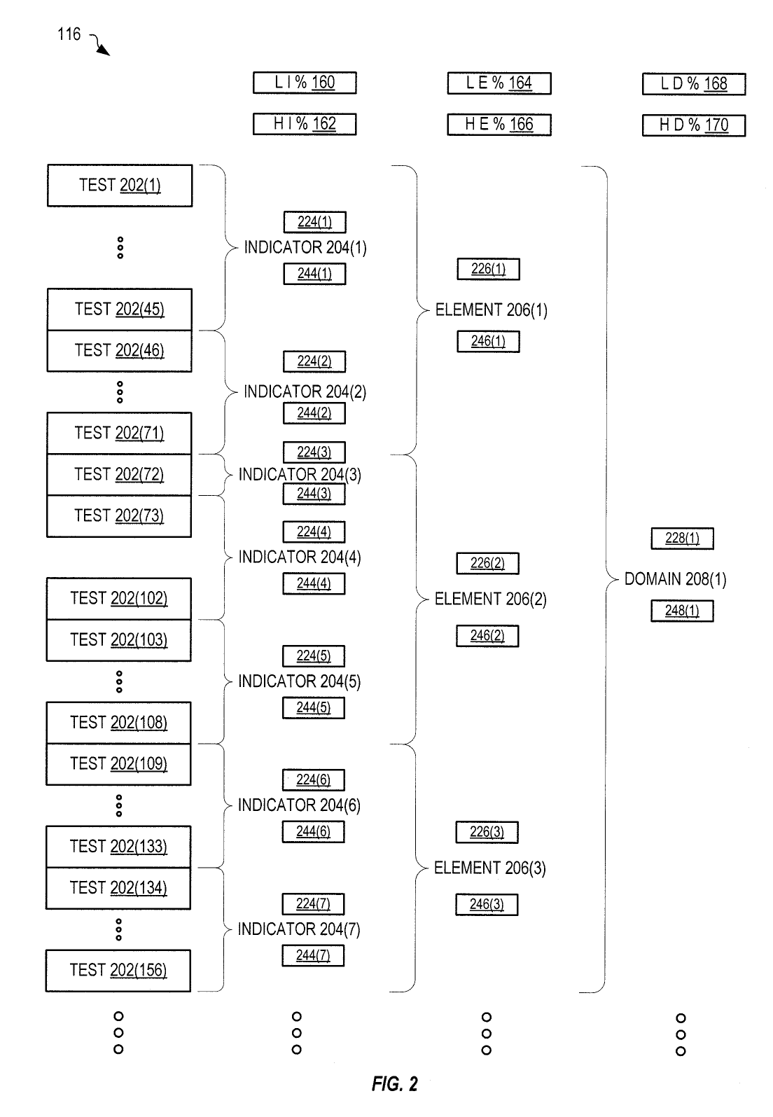

FIG. 2 shows a portion of exemplary assessment data 116 that includes six-hundred and fifty-three tests 202 grouped into seventy-five indicators 204, which are further grouped into twenty-eight elements 206, which are then grouped into seven domains 208. Tests 202 represent tests or tasks that the child can be observed to accomplish. For example, when testing the child, an assessor uses input device 104 of system 100 to input child characteristic data 115, a date of the test, and then indicates which tests 202 the child has accomplished. Where information on the child has previously been entered, system 100 may allow the assessor to select the child from a list. System 100 may present a list of tests 202 to the assessor using output device 110 and receives input from the assessor using input device 104 to indicate which tests have been accomplished by the child. That is, user interface 105 may allow the assessor to interact with software 112 executed by processor 106 and enter indication of tests 202 accomplished by the child, as prompted by system 100. System 100 may also present previously entered indications to the assessor for reference purposes.

Exemplary tests that the child is expected to achieve before the age of three months include: “steadies head (when held on shoulder) indicates”, “steadies head, but does not hold it up while sitting”, and “bends and straightens arms and legs.” Exemplary tests that the child is expected to perform when aged five and older include: “jumps forward ten times,” “stands on one foot momentarily with eyes closed,” “walks balance beam heel to toe,” and “runs 50 yards in 12 seconds.” Tests 202 are selected such that the age at which the child accomplishes each test provides an indication of the child's status. However, since development of each child differs, each test against which the child is evaluated cannot be used as a direct indication of the child's status. That is, a child failing to accomplish one particular test by a certain age does not indicate that the child has problems.

Tests 202 are grouped into indicators 204, where each indicator is based upon one or more tests 202, and each test 202 is assigned to one indicator 204. For each indicator 204, the number of tests 202 accomplished by the child is determined and compared to standard number 121 that a child of that age is expected to have accomplished. Standard number 121 is determined from standards data 120 based upon the indicator and the age of the child at the time of the test. For example, at the age of 2 years and six months, a child is expected to have accomplished seven out of a total of twenty-six tests 202 within indicator 204(2). Each individual test 202 does not provide a direct indication of the child's status. Rather, each indicator 204 is evaluated against standard number 121 for that indicator as determined from standards data 120 based upon the child's age. In one embodiment, each indicator 204 represents a sum of accomplished tests 202 within the group of tests associated with that indicator.

Indicators 204 are grouped into elements 206, where each element 206 includes at least one indicator 204, and each indicator 204 belongs to only one element 206. Each element 204 provides a high (more generalized) level of analysis based upon indicators 204. Each element 206 may be represented by a value that is the sum of indicator 204 values. That is, the value of each element 206 is the sum of accomplished tasks 202 within that element. Continuing with the example of FIG. 2, element 206(1) may represent “gross motor skills,” and include indicators 204(1) and 204(2), where indicator 204(1) includes tests 202(1)-202(45) and indicator 204(2) includes tests 202(46)-202(71). Thus, a value of element 206(1) is the sum of accomplished tests 202(1)-202(71). Similarly, element 206(2) includes indicators 204(3)-204(5), which include tests 202(72)-202(108). Thus a value of element 206(2) is a sum of accomplished tests 202(72)-202(108). Similarly again, element 206(3) includes indicators 204(6)-204(7), which include tests 202(109)-202(156). Thus a value of element 206(3) is a sum of accomplished tests 202(109-202(156).

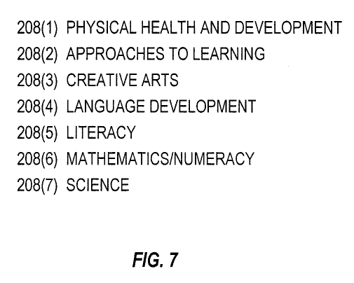

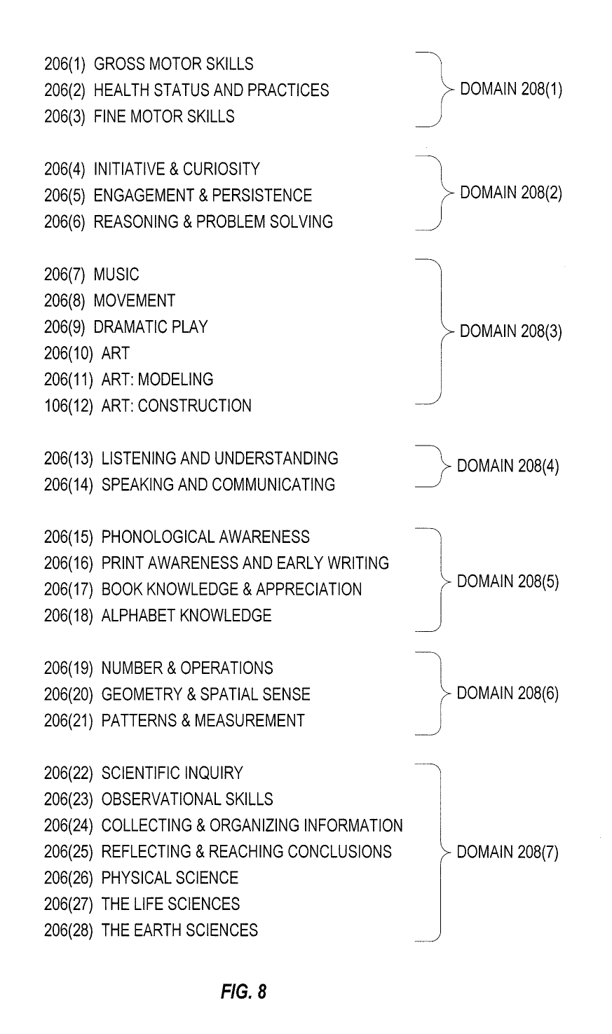

Continuing with the example of FIG. 2, domain 208(1) is one of seven domains (see also FIG. 7), where domain 208(1) represents “physical health and development,” domain 208(2) represents “approaches to learning,” domain 208(3) represents “creative arts,” domain 208(4) represents “language development,” domain 208(5) represents “literacy,” domain 208(6) represents “mathematics/numeracy,” and domain 208(7) represents “science.” In this example, domain 208(1) includes element 206(1) representing “gross motor skills,” element 206(2) representing “health status and practices,” and element (3) representing “fine motor skills.” See also FIG. 8. Thus, a value of domain 208(1) is a sum of accomplished tests 202(1)-202(156). The number of tests 202, indicators 204, elements 206, and domains 208 may vary without departing from the scope hereof.

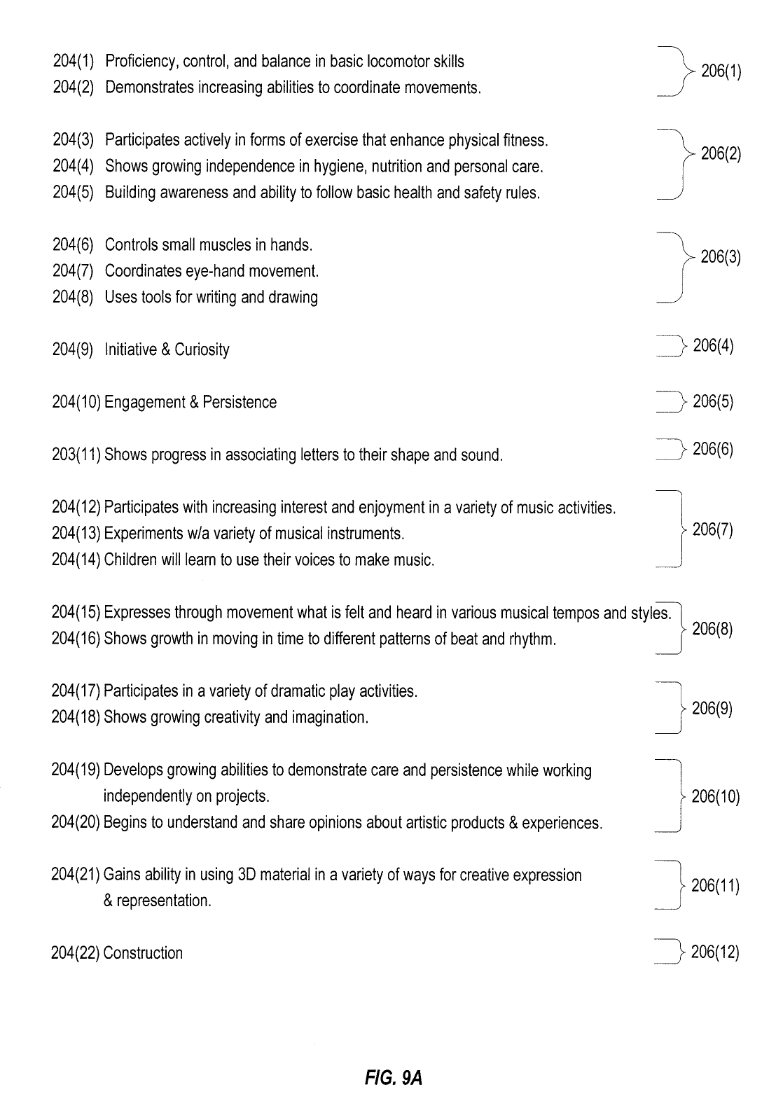

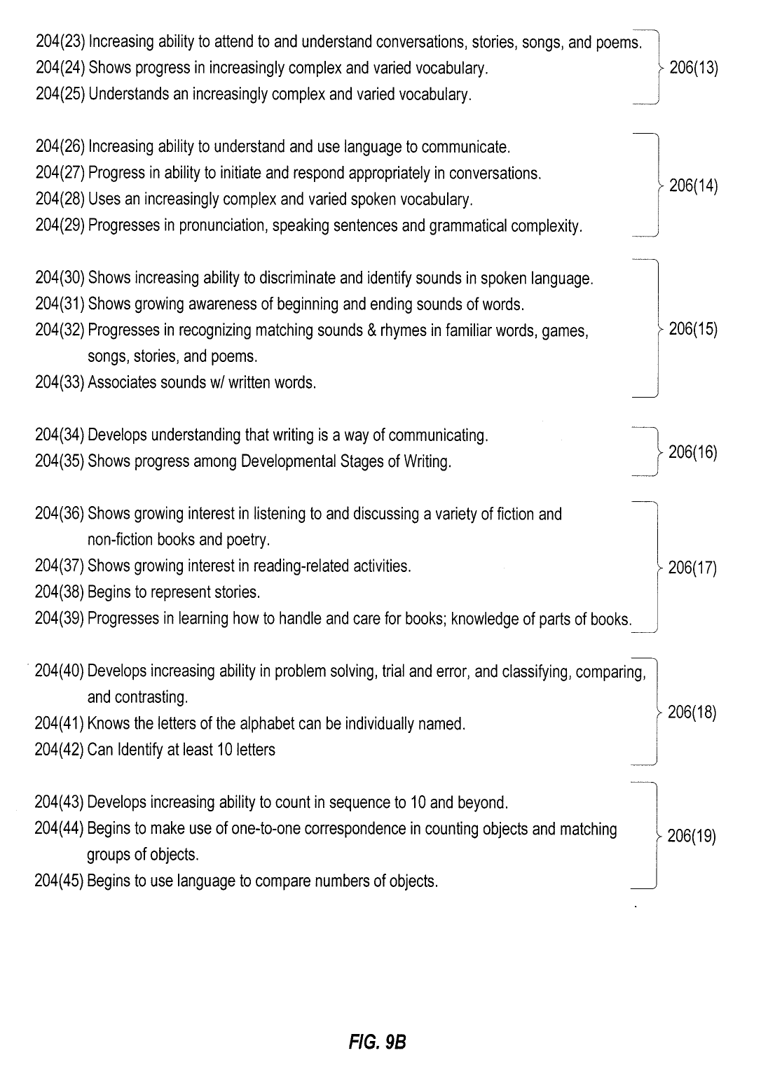

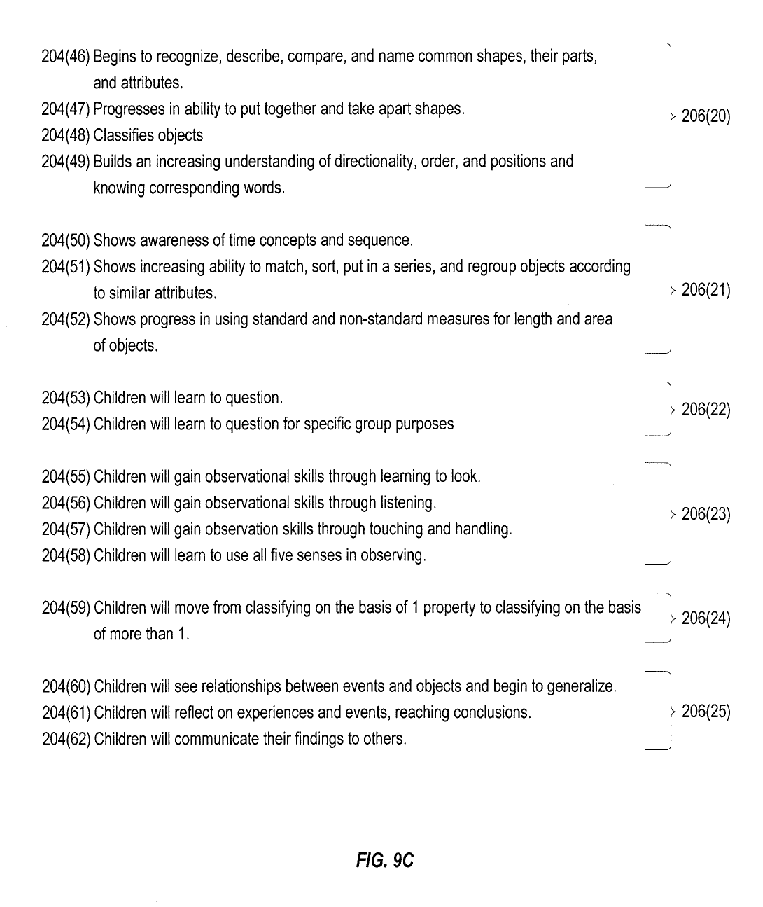

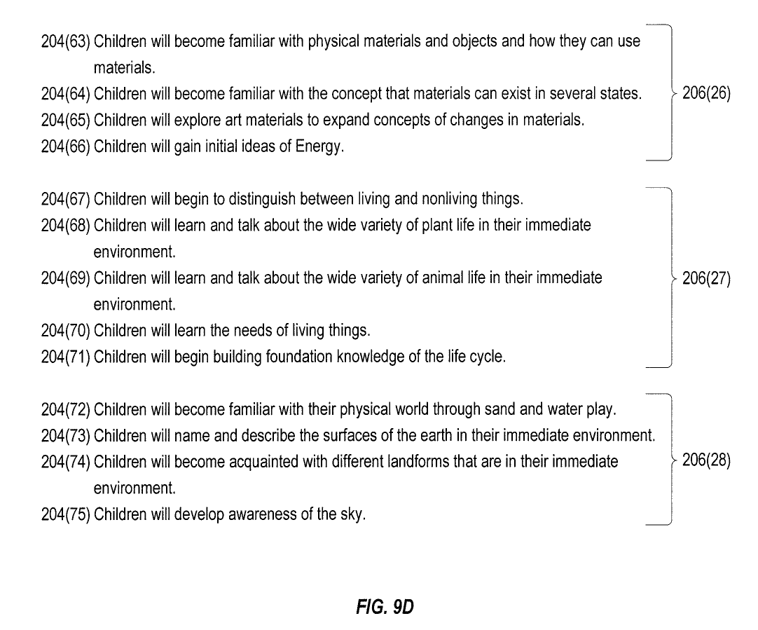

FIG. 7 shows seven exemplary domains 208(1)-208(7) of assessment data 116, where each domain covers a different educational area. FIG. 8 shows twenty-eight exemplary elements 206(1)-206(28) grouped by domains 208 of FIG. 7. FIGS. 9A-9D show exemplary indicators 204(1)-204(75) grouped by elements 206 of FIG. 8. FIGS. 7-9D illustrate exemplary educational developmental areas for assessment grouped into domains 208, elements 206, and indicators 204 within assessment data 116.

Each indicator 204 is based upon one or more tests 202 that assess the abilities and accomplishments of the child. Each test 202 is selected based upon a standard age that the child is expected to accomplish the test, and is for example based upon one or more of a task, an achievement, and awareness that the child may be observed to demonstrate to the assessor.

The child may be assessed periodically (e.g., bi-annually) such that accomplishments of the child are accumulated within assessment data 116 of system 100 and may be analyzed to assess both a current status and development of the child.

By grouping tests 202 into indicators 204, elements 206, and domains 208, system 100 determines whether the child has multiple deficiencies within any one or more domains, any one or more elements, and for any one or more indicators such that appropriate interventions may be determined and applied to the child. Further testing may be used to monitor improvements to the child's accomplishments resulting from applied interventions. System 100 may also provide evaluation of teaching staff, and the interventions themselves.

FIG. 2 also shows predefined high and low percentages for each of indicators 204, elements 206, and domains 208. Low indicator percentage 160 is used to calculate a minimum number of tests within each indicator that the child is expected to have accomplished. High indicator percentage 162 is used to calculate a maximum number of tests within each indicator that the child is expected to have accomplished. The minimum and maximum numbers define a range for the indicator that is considered typical for a child. Similarly, low element percentage 164 is used to calculate a minimum number of tests within each element that the child is expected to have accomplished. High element percentage 166 is used to calculate a maximum number of tests within each element that the child is expected to have accomplished. The minimum and maximum numbers define a range for the element that is considered typical for a child. Similarly again, low domain percentage 168 is used to calculate a minimum number of tests within each domain that the child is expected to have accomplished. High domain percentage 170 is used to calculate a maximum number of tests within each domain that the child is expected to have accomplished. The minimum and maximum numbers define a range for the domain that is considered typical for a child. These predefined percentage values 160-170 are for example stored within memory 108 of system 100, and are illustratively shown in FIG. 2. The low percentage values 160, 164, and 168 may be different or the same, and the high percentage values 162, 166, and 170 may be different or may be the same. Typical percentage values, as used in the examples herein, are 75% for low percentages 160, 164, and 168, and 125% for high percentages 162, 166, and 170.

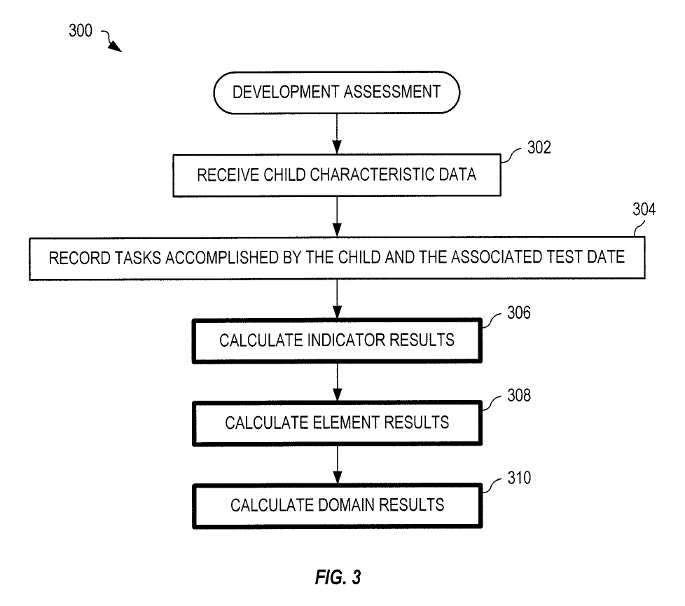

FIG. 3 is a flowchart illustrating one exemplary process 300 for educational assessment support. Process 300 is for example implemented within software 112 of system 100.

Child characteristics 115 are received in step 302 of process 300. In one example of step 115, the assessor enters the child's name, the enrollment date, the child's birth date, the neighborhood in which the child lives, the class of the family, the gender of the child, the child's race, whether the child is considered high risk, whether a parent of the child graduated from high school, whether the child has three or more siblings, and whether the child has had chronic homelessness. The assessor then, in step 304 of process 300, records task accomplished by the child together with the associated test data. In one example of step 304, the assessor clicks on each accomplished test 202 within a displayed list of tests, and system 100 automatically enters the date of the test.

In step 306, a sub-process 400 is invoked to calculate indicator results. In step 308, a sub-process 500 is invoked to calculate element results. In step 310, a sub-process 600 is invoked to calculate domain results. In one embodiment, sub-processes 400, 500, and 600, are invoked after each indication of a task accomplished by the assessor. In another embodiment, the assessor indicated that all task entry is complete, wherein process 300 invokes each sub-process 400, 500, and 600, in turn.

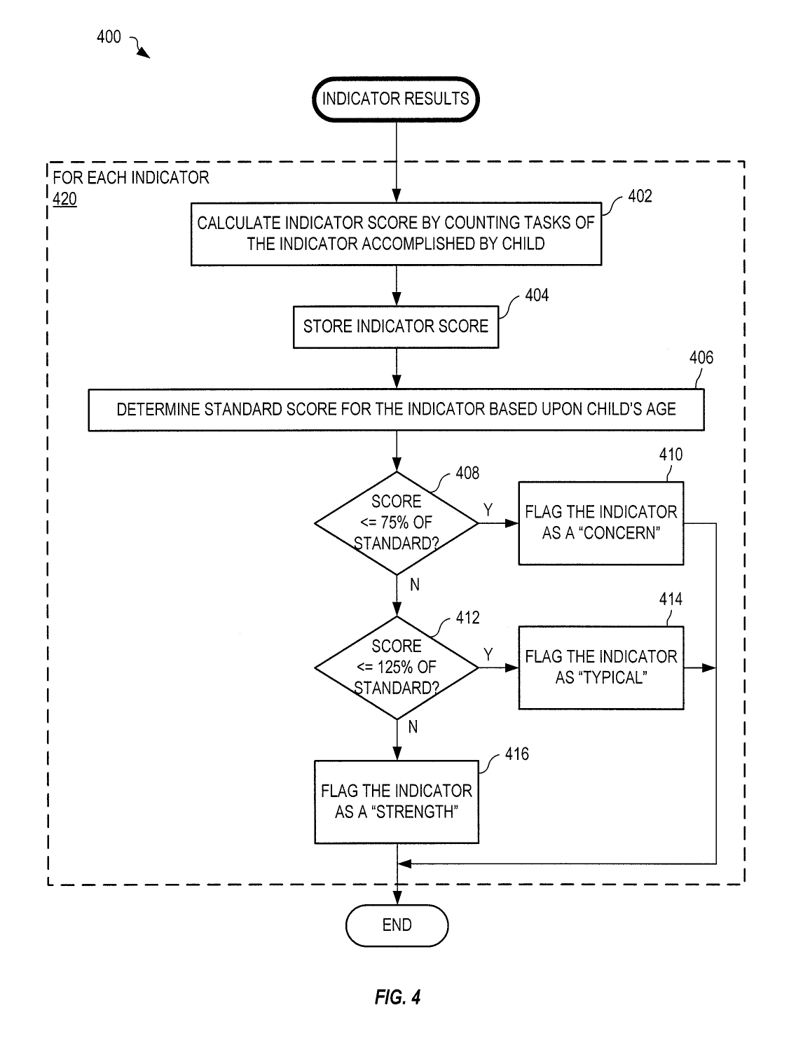

FIG. 4 shows one exemplary sub-process 400 for calculating indicator results when invoked from step 306 of process 300, FIG. 3. Sub-process 400 is for example implemented within software 114 of system 100. Steps 402 through 416 are repeated for each indicator 204, as indicated by dashed outline 420.

In step 402, system 100 calculates an indicator score 224 by counting tasks associated with the indicator that have been accomplished by the child. In one example of step 402, system 100 selects tests 202(1)-202(45) of indicator 204(1) and counts the number of these tasks indicated as having been accomplished (within current and previous testing) by the child to produce indicator score 224(1) for indicator 204(1).

System 100 then, in step 404 of sub-process 400, stores indicator score 224 within assessment results 140 of database 114. In step 406 of sub-process 400, system 100 determines standard number 121 for the indicator based upon the child's age using standards data 120. In one example of step 406, standard number 121 is retrieved from standards data 120, which is a lookup table indexed by the child's age in months and an index number of the indicator, and where standard number 121 is the number of tests 202 that the child is expected to have accomplished within the indicator group by that age.

Step 408 of sub-process 400 is a decision. If, in step 408, system 100 determines that the calculated indicator score 224 of step 402 is less than or equal to low indicator percentage 160 of the determined standard number 121 of step 406, sub-process 400 continues with step 410; otherwise sub-process 400 continues with step 412. In step 410 of process 400, system 100 flags the indicator as a ‘concern’ for the child within assessment results 140. Steps 402 through 416 of sub-process 400 then repeat for the next indicator 204, or sub-process 400 returns control to process 300 if all indicators have been processed.

Step 412 of sub-process 400 is a decision. If, in step 412, system 100 determines that the calculated indicator score of step 402 is less than or equal to high indicator percentage 162 of the determined standard number 121 of step 406, sub-process 400 continues with step 414; otherwise sub-process 400 continues with step 416. In step 414 of process 400, system 100 flags the indicator as “typical” for the child within assessment results 140. Steps 402 through 416 of sub-process 400 then repeat for the next indicator 204, or sub-process 400 returns control to process 300 if all indicators 204 have been processed.

In step 416 of process 400, system 100 flags the indicator as “strength” for the child within assessment results 140. Steps 402 through 416 of sub-process 400 then repeat for the next indicator 204, or sub-process 400 returns control to process 300 if all indicators 204 have been processed.

Once sub-process 400 completes, assessment results 140 contains an indicator score and a flag for each indicator 204. Software 112 may generate one or more graphs, tables and other displays of indicator scores and/or flags from assessments results 140 for one or more indicators 204.

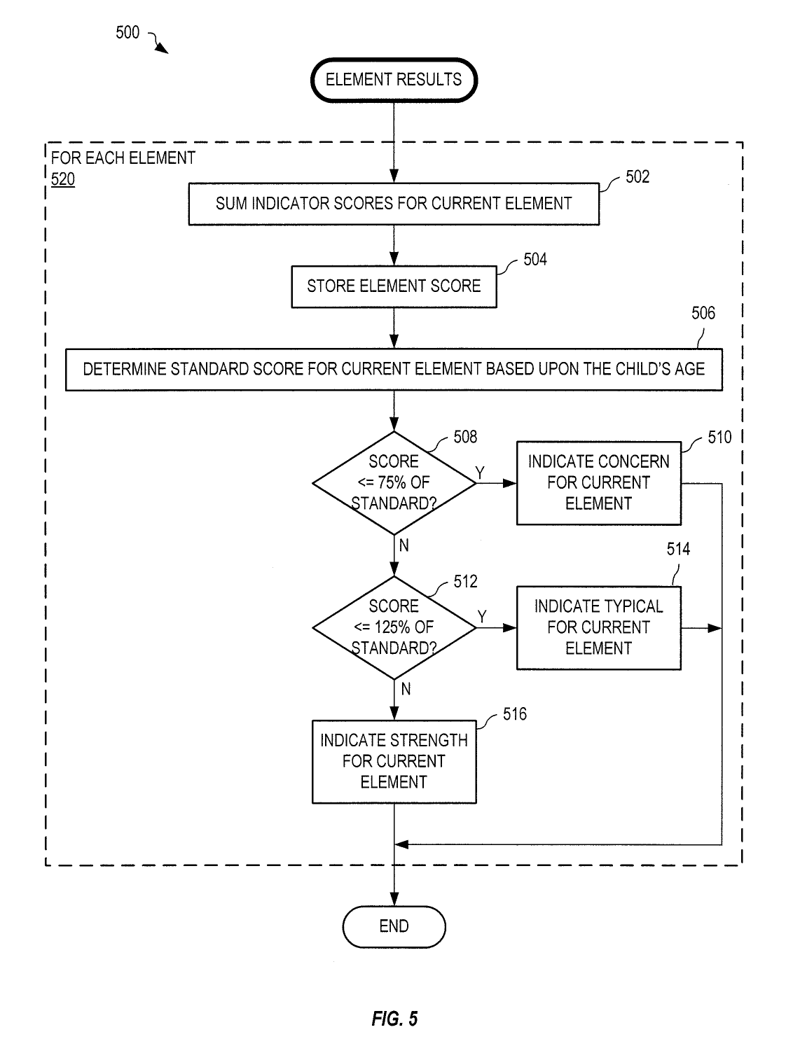

FIG. 5 shows one exemplary sub-process 500 for calculating element results when invoked from step 308 of process 300, FIG. 3. Sub-process 500 is for example implemented within software 114 of system 100. Steps 502 through 516 are repeated for each element 206, as indicated by dashed outline 520.

In step 502, system 100 sums indicator scores from assessment results 140 for indicators 204 associated with the current element to form an element score. In one example of step 502, system 100 sums indicator scores of indicators 204(1) and 204(2) to produce the element score for element 206(1).

System 100 then, in step 504 of sub-process 500, stores the element score within assessment results 140 of database 114. In step 506 of sub-process 500, system 100 determines standard number 121 for the element based upon the child's age using standards data 120. In one example of step 506, standard number 121 is determined by summing standard numbers retrieved from standards data 120 for each indicator 204 associated with the current element 206 based upon the age of the child.

Step 508 of sub-process 500 is a decision. If, in step 508, system 100 determines that the calculated element score of step 502 is less than or equal to low element percentage 164 of the determined standard number 121 of step 506, sub-process 500 continues with step 510; otherwise sub-process 500 continues with step 512. In step 510 of process 500, system 100 flags the element as a ‘concern’ for the child within assessment results 140. Steps 502 through 516 of sub-process 500 then repeat for the next indicator, or sub-process 500 returns control to process 300 if all elements 206 have been processed.

Step 512 of sub-process 500 is a decision. If, in step 512, system 100 determines that the calculated element score of step 502 is less than or equal to a high element percentage 166 of the determined standard number 121 of step 506, sub-process 500 continues with step 514; otherwise sub-process 500 continues with step 516. In step 514 of process 500, system 100 flags the element as “typical” for the child within assessment results 140. Steps 502 through 516 of sub-process 500 then repeat for the next element, or sub-process 500 returns control to process 300 if all elements 206 have been processed.

In step 516 of process 500, system 100 flags the element as “strength” for the child within assessment results 140. Steps 502 through 516 of sub-process 500 then repeat for the next element 206, or sub-process 500 returns control to process 300 if all elements 206 have been processed.

Once sub-process 500 completes, assessment results 140 contains an element score and a flag for each element 206. Software 112 may generate one or more graphs, tables and other displays of element scores and/or flags from assessments results 140 for one or more element 206.

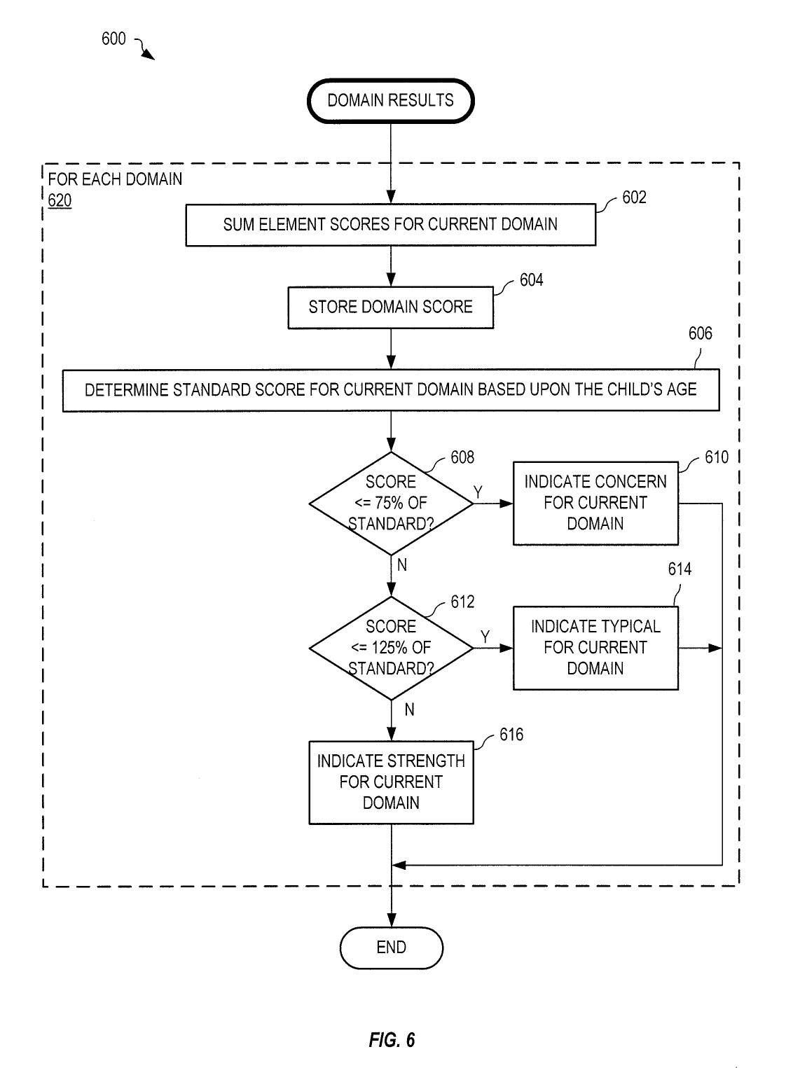

FIG. 6 shows one exemplary sub-process 600 for calculating element results when invoked from step 310 of process 300, FIG. 3. Sub-process 600 is for example implemented within software 114 of system 100. Steps 602 through 616 are repeated for each domain 208, as indicated by dashed outline 620.

In step 602, system 100 sums element scores from assessment results 140 for elements 206 associated with the current domain to form a domain score.

In one example of step 602, system 100 sums element scores of elements 206(1)-206(3) to produce the domain score for domain 208(1).

System 100 then, in step 604 of sub-process 600, stores the domain score within assessment results 140 of database 114. In step 606 of sub-process 600, system 100 determines standard number 121 for the element based upon the child's age using standards data 120. In one example of step 606, standard number 121 is determined by summing standard numbers retrieved from standards data 120 for each indicator 204 associated with each element 206 associated with the current domain 208 based upon the age of the child. Optionally, standard number 121 for each element 206 may be temporarily stored by sub-process 500 such that these stored standard numbers for elements 206 may be summed in step 606.

Step 608 of sub-process 600 is a decision. If, in step 608, system 100 determines that the calculated domain score of step 602 is less than or equal to low domain percentage 168 of the determined standard number 121 of step 606, sub-process 600 continues with step 610; otherwise sub-process 600 continues with step 612. In step 610 of process 600, system 100 flags the domain as a ‘concern’ for the child within assessment results 140. Steps 602 through 616 of sub-process 600 then repeat for the next domain 208, or sub-process 600 returns control to process 300 if all domains 208 have been processed.

Step 612 of sub-process 600 is a decision. If, in step 612, system 100 determines that the calculated domain score of step 602 is less than or equal to high domain percentage 170 of the determined standard number 121 of step 606, sub-process 600 continues with step 614; otherwise sub-process 600 continues with step 616. In step 614 of process 600, system 100 flags the domain as “typical” for the child within assessment results 140. Steps 602 through 616 of sub-process 600 then repeat for the next domain 208, or sub-process 600 returns control to process 300 if all domains 208 have been processed.

In step 616 of process 600, system 100 flags the domain as “strength” for the child within assessment results 140. Steps 602 through 616 of sub-process 600 then repeat for the next domain 208, or sub-process 600 returns control to process 300 if all domains 208 have been processed.

Once sub-process 600 completes, assessment results 140 contains a domain score and a flag for each domain 208. Software 112 may generate one or more graphs, tables and other displays of domain scores and/or flags from assessments results 140 for one or more domains 208.

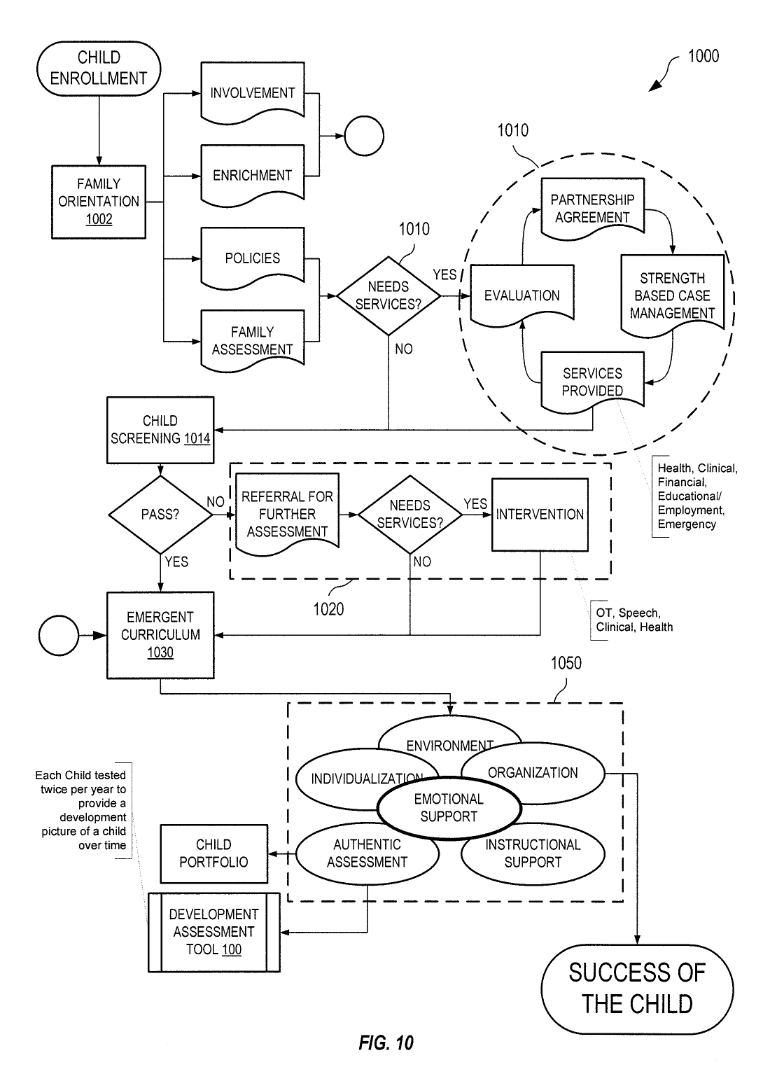

FIG. 10 is a flowchart illustrating one exemplary method 1000 for support of a child using system 100 of FIG. 1. The child is enrolled in a support program and family orientation of the child is determined 1002 and involvement, enrichment, policies, and family assessment reports are produced for further evaluation. It is then determined 1010 whether services are needed for the child, wherein evaluation, agreements, and management determine the service to provide 1012. The child is screened 1014 for suitability for the program and if the child does not pass they may be referred for further assessment and intervention 1020. An emergent curriculum 1030 is formed and provided to an environment for the child where emotional support, organization, individualization, instructional support, and authentic assessment is provided 1050. The authentic assessment utilized system 100, FIG. 1, to assess the educational development of the child and to provide feedback to the support for the child.

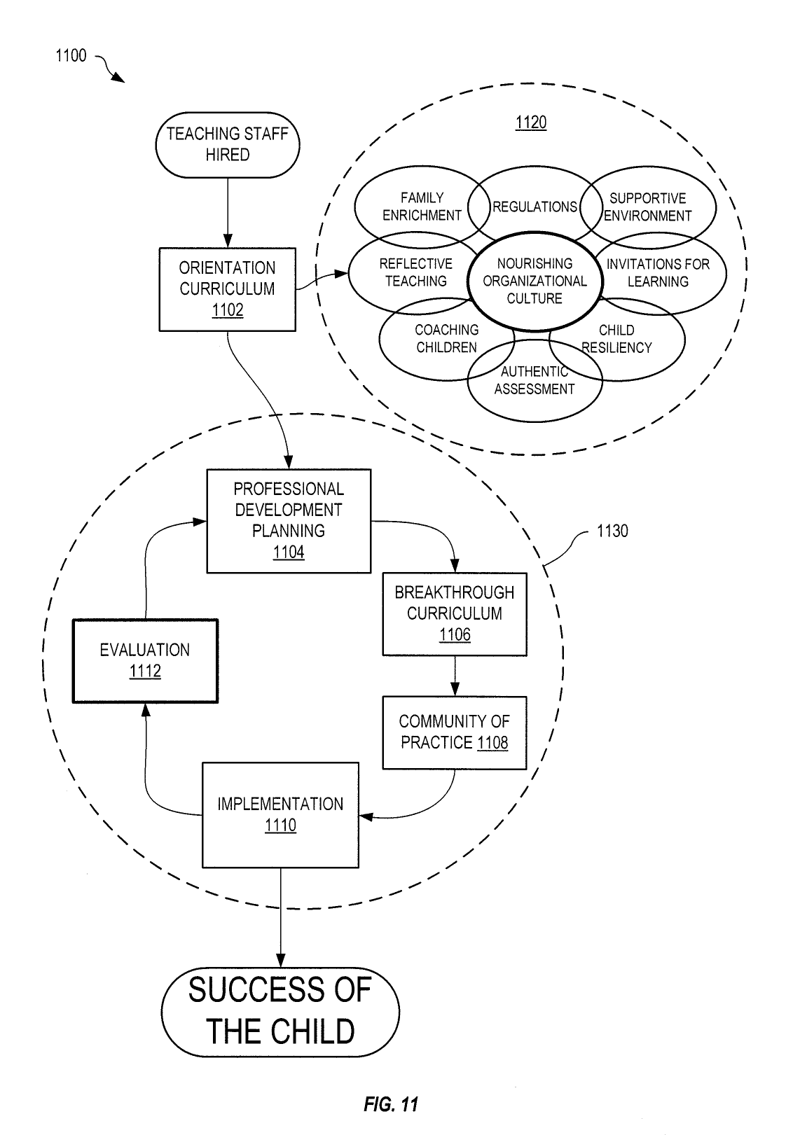

FIG. 11 is a flowchart illustrating exemplary training and assessment of educators using system 100 of FIG. 1. Professional development is a key part of the collaborative program and relies upon the accurate and detailed assessment of each child using system 100. Educators (e.g., teaching staff) are first oriented with the curriculum 1102 that is developed to provide a nourishing organizational culture 1110 with accent upon family enrichment, regulations, supportive environment, reflective teaching, invitations for learning, coaching children, child resiliency, and authentic assessment.

A continual evaluation and development cycle 1130 includes professional development planning 1104 for creating and improving a breakthrough curriculum 1106, community of practice 1108 enhancements, implementation 1110, and evaluation 1112. For example, assessment report 150 and other information from assessment results 140 from system 100 are used to provide feedback into continual evaluation and development cycle 1130, such that educators may make continual improvements to the education and support provided to the children.

System 100 is a productive assessment tool for assessing, recording, displaying and improving educational development of children. Since system 100 flags strength and concerns for indicators 204 by comparing indicator score 224 to a standard number 121 that is determined for the indicator using the age of the child, system 100 does not unduly flag ‘concern’ when any one particular test has not been accomplished by the child as expected due to the child's age. For example, where a child has strengths in one area, but weaknesses in another, the present system assesses the overall accomplishments of the child within each indicator, element, and domain, and flags concerns when the child assessment indicates a weakness greater than the predefined minimum of a standard range for that indicator/element/domain. Similarly, the system flags strength within each indicator, element, and domain, when the child excels beyond a maximum for that standard range.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A computer-implemented method for educational assessment of a child comprising:
receiving characteristics of the child including indicia of the age of the child;
receiving inputs based upon assessment of the child including indicators of:
physical health and development,
approaches to learning,
creative arts,
language development,
literacy,
mathematics, and
science; and
generating, in response to said inputs and said indicia, an education assessment report, including:
(a) indicators of the child's areas of strength;
(b) indicators of the child's areas of concern; and
(c) intervention recommendations based upon the indicators (a) and (c).

2. The method of claim 1, wherein the step of receiving inputs comprises receiving, for each of a plurality of tests, an indication of completion of the test by the child and the date of the test, and wherein the step of generating comprises:
for each indicator of a plurality of indicators having a group of said tests related by educational development area:
summing, for each indicator, the number of tests accomplished by the child to form an indicator score;
determining a minimum and maximum number of tests that the child is expected to have accomplished for the indicator based upon standards data and said indicia; and
flagging whether the indicator score is less than the minimum number, greater than the maximum number, or within the range of the minimum and maximum numbers.

3. The method of claim 2, wherein the flagging defines the indicators of the child's areas of strength and the indicators of the child's areas of concern.

4. The method of claim 2, wherein the step of generating further comprises:
for each element of a plurality of elements having a group of said indicators related by educational development area:
summing, for each element, the indicator score of each included indicator to form an element score;
determining a minimum and maximum number of tests that the child is expected to have accomplished for the element based upon standards data and said indicia; and
flagging whether the element score is less than the minimum number, greater than the maximum number, or within the range of the minimum and maximum numbers.

5. The method of claim 4, wherein the flagging of the element score defines the indicators of the child's areas of strength and the indicators of the child's areas of concern.

6. The method of claim 4, wherein the step of generating further comprises:
for each domain of a plurality of domains having a group of said elements related by educational development area:
summing, for each domain, the element score of each included element to form a domain score;
determining a minimum and maximum number of tests that the child is expected to have accomplished for the domain based upon standards data and said indicia; and
flagging whether the domain score is less than the minimum number, greater than the maximum number, or within the range of the minimum and maximum numbers.

7. The method of claim 6, wherein the flagging defines the indicators of the child's areas of strength and the indicators of the child's areas of concern.

8. A computer-implemented system for educational assessment of a child comprising:
an input device for receiving a date of testing and indicators of tests accomplished by the child;
an output device;
a memory for storing (a) assessment data including the date and the indicators of the tests accomplished, (b) standards data defining a standard number of tests within each of a plurality of indicators that group the tests into areas of education development;
a processor coupled to the input device, the output device, and the memory; and
software, stored within the memory, that when executed by the processor perform the steps of:
receiving characteristics of the child including a birth date;
receiving inputs based upon assessment of the child including indicators of: physical health and development, approaches to learning, creative arts, language development, literacy, mathematics/numeracy, and science; and
generating, in response to said inputs and said birth date, an education assessment report including:
(a) indicators of the child's areas of strength,
(b) indicators of the child's areas of concern, and
(c) intervention recommendations based upon the indicators (a) and (b).

9. The system of claim 8, wherein the step of receiving inputs comprises receiving, for each of a plurality of tests, an indication of completion of the test by the child and the date of the test, and wherein the step of generating comprises:
for each indicator of a plurality of indicators having a group of said tests related by educational development area:
summing, for each indicator, the number of tests accomplished by the child to form an indicator score;
determining a minimum and maximum number of tests that the child is expected to have accomplished for the indicator based upon standards data and said indicia; and
flagging whether the indicator score is less than the minimum number, greater than the maximum number, or within the range of the minimum and maximum numbers, wherein the flagging defines the indicators of the child's areas of strength and the indicators of the child's areas of concern.

10. The system of claim 9, wherein the step of generating further comprises:
for each element of a plurality of elements having a group of said indicators related by educational development area:
summing, for each element, the indicator score of each included indicator to form an element score;
determining a minimum and maximum number of tests that the child is expected to have accomplished for the element based upon standards data and said indicia; and
flagging whether the element score is less than the minimum number, greater than the maximum number, or within the range of the minimum and maximum numbers, wherein the flagging of the element score defines the indicators of the child's areas of strength and the indicators of the child's areas of concern.

11. The system of claim 9, wherein the step of generating further comprises:
for each domain of a plurality of domains having a group of said elements related by educational development area:
summing, for each domain, the element score of each included element to form a domain score;
determining a minimum and maximum number of tests that the child is expected to have accomplished for the domain based upon standards data and said indicia; and
flagging whether the domain score is less than the minimum number, greater than the maximum number, or within the range of the minimum and maximum numbers.

12. The system of claim 11, wherein the flagging of the domain score defines the indicators of the child's areas of strength and the indicators of the child's areas of concern.
